(19) United States
(12) Patent Application Publication
(10) Pub. No.: US 2008/0182106 A1
(43) Pub. Date: Jul. 31, 2008

(54) Method for producing a chemoactive useful layer and sensor having a chemoactive useful layer

(76) Inventors: Rene Jabado, Berlin (DE); Jens Dahl Jensen, Berlin (DE); Ursus Kruger, Berlin (DE); Daniel Kortvelyessy, Berlin (DE); Volkmar Luthen, Berlin (DE); Ralph Reiche, Berlin (DE); Michael Rindler, Shoneiche (DE); Raymond Ullrich, Shonwalde (DE)

Correspondence Address: HARNESS, DICKEY & PIERCE, P.L.C., P.O.BOX 8910, RESTON, VA, 20195, US

(21) Appl. No.: 11/902,262

(22) Filed: Sep. 20, 2007

(30) Foreign Application Priority Data
Sep. 21, 2006 (DE) 10 2006 045 532.0

(51) Int. Cl. B32B 27/14; B05D 1/12

(52) U.S. Cl. 428/407; 427/180

(57) ABSTRACT

A method is disclosed for producing a chemoactive useful layer and sensor is disclosed, including a chemoactive useful layer. In at least one embodiment, a method is disclosed for producing a chemoactive useful layer. In at least one embodiment, nanoparticles having a catalytic action are introduced into the useful layer.

### PRIORITY STATEMENT

The present application hereby claims priority under 35 U.S.C. §119 on German patent application number DE 10 2006 045 532.0 filed Sep. 21, 2006, the entire contents of which is hereby incorporated herein by reference.

### FIELD

Embodiments of the invention generally relate to a method.

### BACKGROUND

The term “chemoactive useful layer” should be understood hereinafter to mean a useful layer which changes its physical properties upon the action of specific chemicals for which the useful layer is active. A chemoactivity can be for example chemosensitive and be based on a chemoresistive or chemically resistive effect which results in the electrical conductivity of the useful layer being altered. A chemoactivity can also be based on a chemocapacitive or chemically capacitive effect which results in the electrical capacitance of the useful layer being altered. A chemooptical or chemically optical effect results for example in a change in the optical properties, for example the fluorescence properties, of the useful layer. Chemoactive useful layers and methods for producing them are described for example in the published European patent application EP 1 215 485 A1, the entire contents of which are incorporate herein by reference; these methods use linker molecules that are intended to increase the selectivity of the useful layer.

### SUMMARY

In at least one embodiment of the invention, a method is disclosed for producing a chemoactive useful layer by which a particularly high sensitivity of the useful layer can be achieved.

Accordingly, at least one embodiment of the invention provides for nanoparticles having a catalytic action to be introduced into the useful layer. The catalytic action is brought about by the nanoparticles acting catalytically wholly or in sections—for example in the particle core.

Nanoparticles are understood hereinafter to mean particles having a particle size of less than 1 micrometer. Nanoparticles—in contrast to respectively the same material without a nanoparticle structure—have in part very unusual properties. This can be attributed to the fact that the ratio of surface to volume is particularly high in nanoparticles; thus, by way of example, even in the case of spherical nanoparticles comprising a hundred atoms, over fifty atoms are surface atoms. This is the starting point of at least one embodiment of the invention in that at least one embodiment of the invention provides for nanoparticles to be used as catalysts. In this case, a catalytic action within the useful layer should be understood to mean that the nanoparticles or the catalytically acting sections of the nanoparticles increase the reactivity of the useful layer or reduce the reaction energy required for a reaction without the nanoparticles or the catalytically acting sections of the nanoparticles themselves participating here in the chemical reaction. A catalytic action can be based for example on the nanoparticles momentarily “lending” electrons in order that the chemoactive substances of the useful layer, for example polymers, or else other non-catalytic sections of the nanoparticles can perform the corresponding reactions; after the conclusion of the corresponding reactions, the electrons return to the catalyst or catalyst section again, such that the latter is ultimately not altered chemically.

The function of the catalytically acting nanoparticles or of the catalytically acting sections of the nanoparticles therefore primarily consists in initiating an improved reaction of the useful layer, but not themselves reacting chemically. By way of example, the catalytic action can be based on the fact that as a result of electrons being made available momentarily, electron orbitals of the useful layer spatially flip over, in which case, after the orbitals have flipped over, the electrons participating in initiating the flipping over return to the catalyst nanoparticle again. By means of the catalytically acting nanoparticles that are additionally provided according to the invention, the sensitivity of the useful layer can be significantly improved compared with useful layers without such catalyst nanoparticles.

In accordance with a particularly preferred configuration of at least one embodiment of the method, enveloped nanoparticles having a core/shell structure are produced as nanoparticles by way of a particle core being produced from a material that acts catalytically and the particle core subsequently being coated with a particle shell composed of a polymer material. The coating with the polymer material is in this case effected in such a way that the particle shell forms a closed polymer film around the respective particle core. Only afterward is the useful layer formed with the nanoparticles enveloped in this way. An advantage of this configuration of at lest one embodiment of the method can be seen in the fact that the catalytically effective part of the nanoparticles is firstly embedded in order to achieve an overall better incorporation of the nanoparticles in the useful layer and thereby to improve the catalytic action of the nanoparticles within the useful layer.

Preferably, the particle shell is produced from a chemoactive polymer; this is because in this case, for example, the entire useful layer can be produced by exclusively applying the enveloped nanoparticles on a substrate, the enveloped nanoparticles which adjoin one another forming the useful layer. In this configuration of the method, therefore, no nanoparticles are introduced into a foreign useful layer, rather the useful layer is instead formed as such by previously enveloped nanoparticles.

As an alternative, the enveloped nanoparticles can also be embedded into a carrier layer material with formation of the useful layer. In this case, the carrier layer material and the polymer material of the particle shell can be identical or different.

Preferably, such a carrier layer material has chemoactive nanoparticles which bring about or improve the chemical activity of the useful layer. By adding suitable nanoparticles specifically “tailored” to the respective requirement, the property of the useful layer can then be established in a highly targeted manner. As an alternative or in addition, the carrier layer material itself can also comprise a chemoactive polymer that inherently manifests a chemoactive action.

After the particle cores have been coated with the polymer material of the particle shell, the latter can be cured before the actual useful layer is formed with the enveloped nanoparticles. As an alternative, the particle cores can also be enveloped within a suspension in such a way that the useful layer is formed after the particle cores have been enclosed in their respective particle shell with the same suspension; in this case, therefore, prior curing of the particle shell is not necessary. The enveloping in a suspension can be effected for example in a “layer-by-layer” technique such as is offered by the company Capsulution NanoScience AG in Berlin.

A catalytic action is exhibited by for example gold, silver, platinum, iridium, ruthenium and rhodium, with the result that it is regarded as advantageous if the particle cores are produced from one or a plurality of said metals or from a metal mixture of the metals.

At least one embodiment of the invention furthermore relates to a chemoactive sensor having a chemoactive useful layer.

In order to achieve a particularly high sensitivity in the case of such a chemoactive sensor, the invention proposes that the useful layer contains nanoparticles having a catalytic action.

With regard to the advantages of the chemoactive sensor according to at least one embodiment of the invention, reference should be made to the above explanations in connection with the method according to at least one embodiment of the invention for producing a chemoactive useful layer, since the advantages of the method according to at least one embodiment of the invention and also the advantages of the chemoactive sensor according to the invention essentially correspond to one another. The same correspondingly holds true for advantageous configurations of the chemoactive sensor.

### BRIEF DESCRIPTION OF THE DRAWINGS

The invention is explained in more detail below on the basis of example embodiments; in this case, by way of example,

FIG. 1 shows a first example embodiment of a chemoactive sensor according to the invention, on the basis of which an example embodiment of the method according to the invention is also elucidated,

FIG. 2 shows a second example embodiment of a chemoactive sensor according to the invention, in which the useful layer is formed by nanoparticles having a core/shell structure which adjoin one another,

FIG. 3 shows a third example embodiment of a chemoactive sensor according to the invention, in which catalytically acting nanoparticles are embedded together with chemo actively acting nanoparticles in a carrier layer material,

FIG. 4 shows a fourth example embodiment of a chemoactive sensor according to the invention, in which catalytically acting nanoparticles without a core/shell structure are embedded in a chemoactive carrier material,

FIG. 5 shows a fifth example embodiment of a chemoactive sensor according to the invention, in which a carrier layer material contains chemoactive nanoparticles and also catalytically acting nanoparticles without a core/shell structure, and

FIG. 6 shows a sixth example embodiment of a chemoactive sensor according to the invention, in which a carrier layer material containing polyolefin contains nanoparticles based on vanadium, palladium, vanadium oxide and/or palladium oxide.

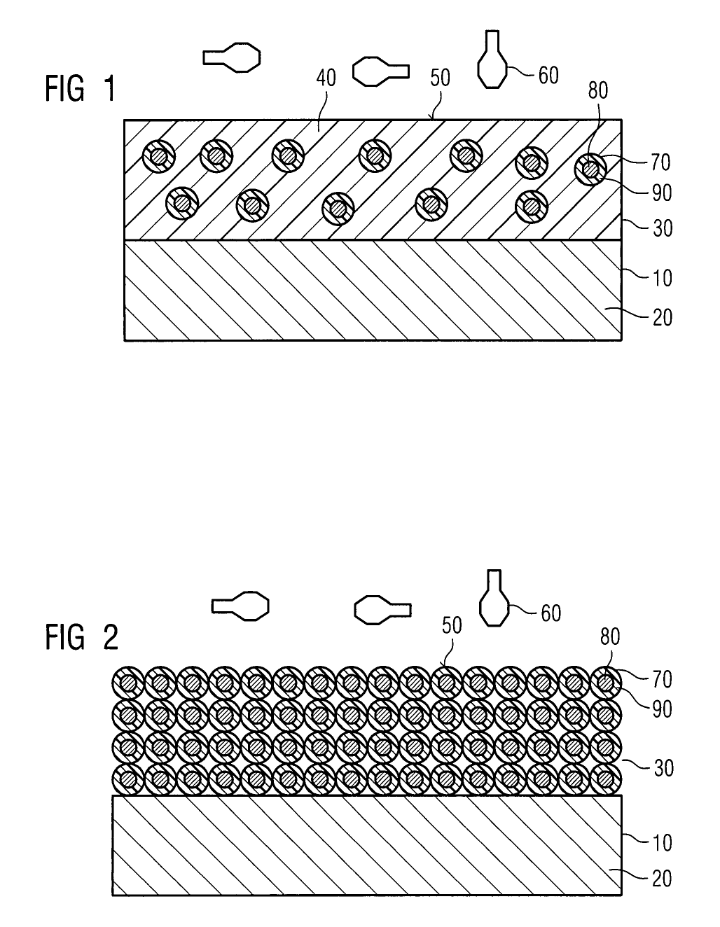

In FIGS. 1 to 6, the same reference symbols are always used for identical or comparable components, for the sake of clarity.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

FIG. 1 reveals an example embodiment of a chemoactive sensor 10, which is equipped with a substrate 20 and also a chemoactive or chemically active useful layer 30. The chemoactive useful layer 30 comprises a carrier layer material 40 having a chemoactive action. By way of example, the carrier layer material 40 is chemo resistive; this means that it changes its electrical resistance depending on the concentration of a chemical substance 60 to be detected which acts on the surface 50 of the chemoactive useful layer 30. By applying a corresponding voltage and by measuring the resultant current flow through the carrier layer material 40, it is then possible to detect a concentration of the chemical substance 60 to be detected in the region of the surface 50.

As can furthermore be discerned in FIG. 1, the chemoactive useful layer 30 contains nanoparticles 70 having a catalytically acting particle core 80, which manifests a catalytic action. A catalytic action should be understood in this connection to mean that the particle cores 80 do not themselves enter into a chemical compound with the chemical substance 60 to be detected; the function of the catalytically acting particle cores 80 is restricted to improving the sensitivity of the useful layer 30. Such improvement of sensitivity can occur for example by virtue of the fact that the particle cores 80 make electrons available or take them up in the meantime, whereby the chemical docking capability or reactivity between the chemoactive carrier layer material 40 and the chemical substance 60 to be detected is improved. On account of the fact that the particle cores 80 exclusively act catalytically, it is ensured that they cannot themselves be consumed during the operation of the chemoactive sensor 10.

As can furthermore be discerned in FIG. 1, the nanoparticles 70 in each case have a core/shell structure. This means that each nanoparticle 70 is in each case equipped not only with the particle core 80 already mentioned but also with a particle shell 90 enclosing the particle core 80. As already mentioned, the particle core 80 comprises a substance that brings about a catalytic action. The particle shell 90 comprises a polymer selected such that it simplifies or improves the incorporation of the nanoparticles 70 into the carrier layer material 40, such that they can fully manifest their catalytic action.

By way of example, the polymer material or the polymer sheath 90 of the nanoparticles 70 is one and the same material as the carrier layer material 40. This means that the particle shell 90, too, is itself chemoactive and also itself contributes to the chemical activity or reactivity of the useful layer 30.

As an alternative, it is also possible, moreover, for exclusively the particle shell 90 to be chemoactive and solely form the basis for the reactivity of the useful layer 30; in this case, therefore, the carrier layer material 40 would be chemically inactive, for example.

FIG. 2 illustrates a second example embodiment of a chemoactive sensor 10. In this example embodiment, a chemoactive useful layer 30 formed exclusively by enveloped nanoparticles 70 is applied on a substrate 20. Each of the enveloped nanoparticles 70 has in each case a particle core 80 composed of a catalytically acting material such as e.g. gold, silver, platinum, iridium, ruthenium or rhodium or a mixture of said materials. The particle shells 90 of the enveloped nanoparticles 70 in each case comprise a chemoactive polymer material which is correspondingly sensitive for the detection of a substance 60 to be detected which acts on the surface 50 of the chemoactive sensor 10, and changes its physical properties, for example its resistance, its capacitance, or its optical properties depending on the concentration of the chemical substance 60 to be detected.

One important aspect of the second example embodiment is that the chemoactive useful layer 30 is formed exclusively by the enveloped nanoparticles 70 and that accordingly no further carrier layer material is required for forming the useful layer. Optionally, the enveloped nanoparticles 70 can be combined with one another by means of a binder or adhesive in order to improve the layer stability.

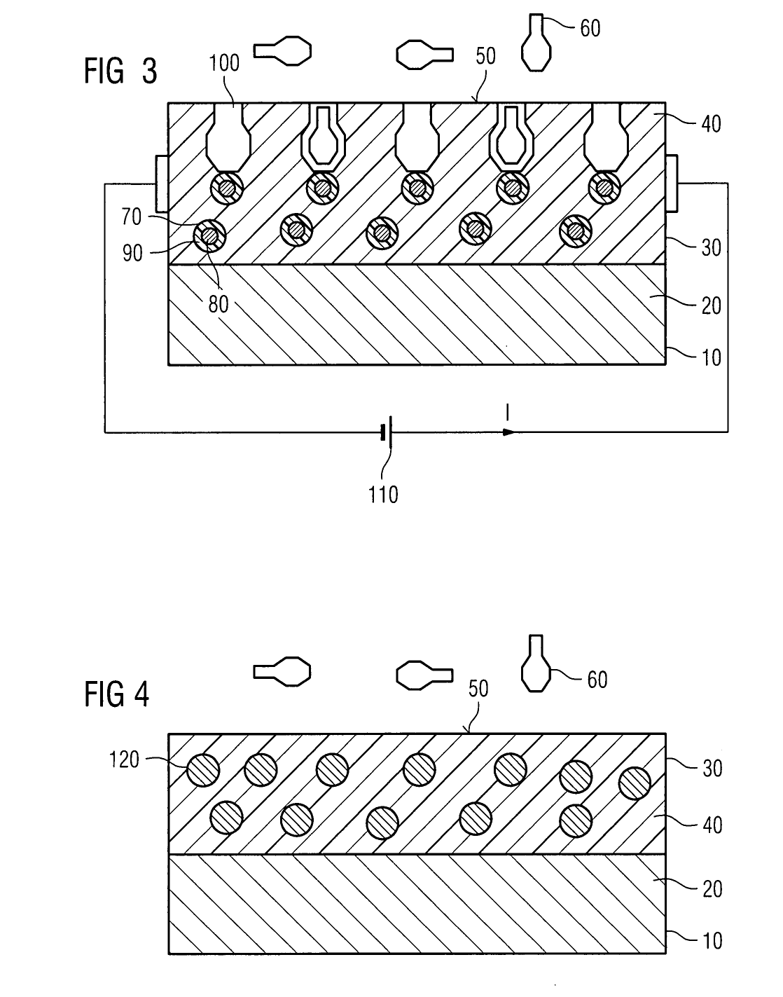

FIG. 3 shows a third example embodiment of a chemoactive sensor 10.

A chemoactive useful layer 30 is situated on a substrate 20 of the sensor 10. Chemoactive nanoparticles 100 are introduced in a chemoactive or chemo inactive carrier layer material 40. The carrier layer material 40 can be a polymer, for example. The chemoactive nanoparticles 100 clearly work according to a key-lock principle; this means that the chemical substance 60 can dock chemically onto the chemoactive nanoparticles 100.

The function of the chemoactive nanoparticles 100 consists in altering the physical properties of the chemoactive useful layer 30 depending on the concentration of the chemical substance 60 to be detected; by way of example, the electrical resistance of the chemoactive useful layer 30 is influenced depending on the concentration of the chemical substance 60 to be detected, which can be ascertained by applying an electrical voltage with the aid of a voltage source 110 and measuring the corresponding current I through the chemoactive useful layer 30.

In order to increase the sensitivity of the chemoactive useful layer 30, catalytically acting nanoparticles 70 are in each case docked chemically onto the chemoactive nanoparticles 100 or chemically linked to the latter; thus, the catalytically acting nanoparticles 70 interact with the chemoactive nanoparticles 100. Such interaction consists for example in the fact that the catalytically acting nanoparticles 70 momentarily make electrons available or block electrons in order to improve a chemical reaction between the respectively assigned chemoactive nanoparticle 100 and the chemical substance 60 to be detected.

In the case of the example embodiment in accordance with FIG. 3, the catalytically acting nanoparticles 70 are in each case formed in a core/shell structure; this means that each nanoparticle 70 in each case has a catalytically acting particle core 80 and also a polymer sheath 90 surrounding the particle core 80. The function of the polymer sheath 90 consists in improving the capability of incorporating the nanoparticles 70 into the carrier layer material 40.

FIG. 4 illustrates a fourth example embodiment of a chemoactive sensor. The example embodiment in accordance with FIG. 4 essentially corresponds to the exemplary embodiment in accordance with FIG. 1. In contrast to the example embodiment in accordance with FIG. 1, nanoparticles 120 not having a core/shell structure are inserted into the carrier layer material 40. In contrast to the nanoparticles 70 in accordance with FIG. 1, therefore, the nanoparticles 120 exclusively comprise a catalytically acting material, such as, for example gold, silver, platinum, iridium, ruthenium or rhodium or a mixture of the metals.

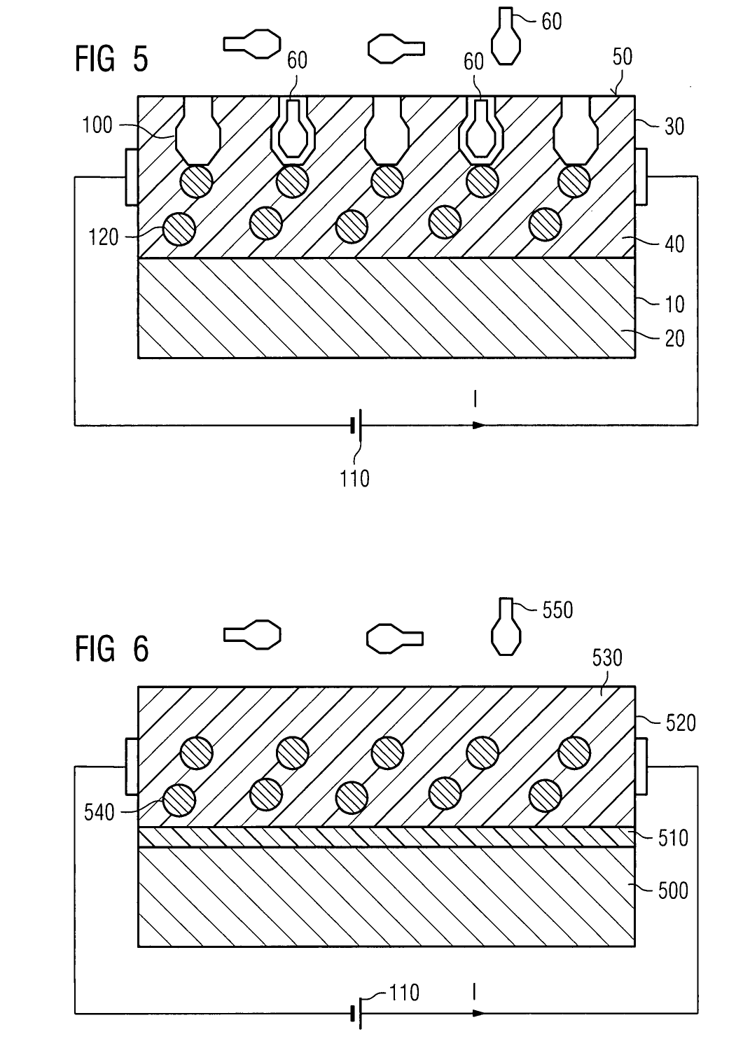

FIG. 5 illustrates a fifth example embodiment of a chemoactive sensor 10. The fifth example embodiment essentially corresponds to the third example embodiment with the difference that nanoparticles 120 without a core/shell structure are used instead of the enveloped catalytically acting nanoparticles 70. The nanoparticles 120 comprise, for example, one or a plurality of the catalytically acting metals already mentioned.

FIG. 6 illustrates a sixth example embodiment of a sensor according to the invention. A carrier 500 composed of metal can be seen, which is heated to a predetermined temperature of 200° C., for example, by way of a heating device (not illustrated further). The carrier 500 is coated with an insulator layer 510, on which a sensor layer 520 is applied as chemoactive chemo resistor useful layer. The sensor layer 520 has carrier layer material 530 composed of conductive plastic, for example composed of or comprising polyolefin, and also nanoparticles 540 composed of or comprising vanadium, palladium, vanadium oxide and/or palladium oxide, which act as a catalyst.

The sensor in accordance with FIG. 6 is operated as follows: firstly, the carrier 500 is heated to the predetermined temperature of 200° C., for example, by way of the heating device. If a substance or analyte 550 to which the sensor layer 520 is sensitive then comes into contact with the surface of the sensor layer, then oxidation of the sensor layer 520 will take place on account of the catalyst properties of the nanoparticles, whereby said sensor layer will be completely destroyed. As a result, the electrical resistance of the sensor layer 520 will thereby be significantly increased, which can be ascertained by way of a corresponding measurement.

The concept in the case of the example embodiment in accordance with FIG. 6 resides in the fact that catalysts based on vanadium or palladium or vanadium oxide, palladium oxide or titanium oxide can lead to an oxidation reaction upon the action of the analyte to be detected in a polymer or plastic. As a result of such oxidization, the polymer or the plastic is broken up with regard to its molecular structure and completely destroyed by combustion, and the electrical resistance of the material is significantly increased. On account of the destruction, although sensors of this type are only suitable for a single detection operation and having a “positive” outcome, the sensitivity of the sensors is very high, such that they can be used for example for detecting drugs or explosives; a single pH measurement as a “litmus test” would also be a possible area of use.

It goes without saying that the nanoparticles 540 can alternatively also have a core/shell structure with a polymer sheath layer, the core of the nanoparticles 540 containing vanadium, palladium, vanadium oxide and/or palladium oxide.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for producing a chemoactive useful layer, comprising:
introducing nanoparticles having a catalytic action into the useful layer.

2. The method as claimed in claim 1, further comprising:
producing enveloped nanoparticles having a core/shell structure as nanoparticles by way of a particle core being produced from a material that acts catalytically in the useful layer, the particle core subsequently being coated with a particle shell composed of a polymer material in such a way that the particle shell forms a closed polymer film around the respective particle core, and
forming, only afterward, the useful layer with the enveloped nanoparticles.

3. The method as claimed in claim 2, wherein the particle shell are produced from a chemoactive polymer, and the enveloped nanoparticles are applied on a substrate, the useful layer beings formed by the enveloped nanoparticles adjoining one another.

4. The method as claimed in claim 2, wherein the enveloped nanoparticles are embedded into a carrier layer material with formation of the useful layer.

5. The method as Claimed in claim 4, wherein the carrier layer material and the polymer material of the particle shell are identical.

6. The method as claimed in claim 4, wherein the carrier layer material and the polymer material of the particle shell are different.

7. The method as claimed in claim 4, wherein the carrier layer material has chemoactive nanoparticles which bring about a chemical activity of the useful layer.

8. The method as claimed in claim 4, wherein the carrier layer material comprises a chemoactive polymer.

9. The method as claimed in claim 2, wherein the polymer material of the particle shell is cured before the useful layer is formed with the enveloped nanoparticles.

10. The method as claimed in claim 2, wherein the particle cores are enveloped in a suspension and the useful layer is formed after the particle cores have been enveloped with the suspension.

11. The method as claimed in claim 1, wherein the particle cores are produced from at least one of
gold, silver, platinum, iridium, ruthenium, rhodium, palladium, vanadium, vanadium oxide, palladium oxide and
a mixture of at least one of gold, silver, platinum, iridium, ruthenium, rhodium, palladium, vanadium, vanadium oxide, and palladium oxide.

12. A chemoactive sensor, comprising:
a chemoactive useful layer, the chemoactive useful layer contains nanoparticles including a catalytic action.

13. The chemoactive sensor as claimed in claim 12, wherein the useful layer includes enveloped nanoparticles which have a particle core composed of a catalytically acting material and a particle shell composed of a polymer material that encloses the particle core.

14. The chemoactive sensor as claimed in claim 13, wherein the useful layer is formed by enveloped nanoparticles adjoining one another.

15. The chemoactive sensor as claimed in claim 12, wherein the particle cores comprise at least one of gold, silver, platinum, iridium, ruthenium, rhodium, palladium, vanadium, vanadium oxide, palladium oxide and a mixture of at least one of gold, silver, platinum, iridium, ruthenium, rhodium, palladium, vanadium, vanadium oxide, palladium oxide.

16. The chemoactive sensor as claimed in claim 12, wherein the useful layer contains or comprises polyolefin.

17. The method as claimed in claim 5, wherein the carrier layer material has chemoactive nanoparticles which bring about a chemical activity of the useful layer.

18. The method as claimed in claim 6, wherein the carrier layer material has chemoactive nanoparticles which bring about a chemical activity of the useful layer.

19. The chemoactive sensor as claimed in claim 13, wherein the particle cores comprise at least one of gold, silver, platinum, iridium, ruthenium, rhodium, palladium, vanadium, vanadium oxide, palladium oxide and a mixture of at least one of gold, silver, platinum, iridium, ruthenium, rhodium, palladium, vanadium, vanadium oxide, palladium oxide.

20. The chemoactive sensor as claimed in claim 13, wherein the useful layer contains or comprises polyolefin.
